(19) United States
(12) Patent Application Publication
(10) Pub. No.: US 2024/0393794 A1
(43) Pub. Date: Nov. 28, 2024

(54) ADVANCED SLIP CONTROL FOR AN AGRICULTURAL VEHICLE

(71) Applicant: CNH Industrial America LLC, New Holland, PA (US)

(72) Inventors: John Posselius, New Holland, PA (US); Christopher Foster, New Holland, PA (US); Scott Elkins, New Holland, PA (US)

(73) Assignee: CNH Industrial America LLC, New Holland, PA (US)

(21) Appl. No.: 18/322,383

(22) Filed: May 23, 2023

(51) Int. Cl. G05D 1/02

(52) U.S. Cl. CPC G05D 1/0291; A01D 34/008; A01D 2101/00

(57) ABSTRACT

An agricultural vehicle including a control system to control slip of a tractive element. The control system includes processing circuitry configured to obtain an indication of a priority operating parameter from a plurality of operating parameters of the agricultural vehicle. The control system is configured to perform an adjustment to at least one non-priority operating parameter from the plurality of operating parameters of the agricultural vehicle when a first slip value of the tractive element exceeds a threshold. The control system configured to operate the agricultural vehicle according to the adjustment to the at least one non-priority operating parameter. The control system configured to perform an adjustment to the priority operating parameter upon a second slip value of the tractive element exceeding the threshold. The control system configured to operate the agricultural vehicle according to the adjustment to the priority operating parameter.

### BACKGROUND

The present disclosure relates generally to an agricultural vehicle. More specifically, the present disclosure relates to control systems for drivelines of agricultural vehicles.

### SUMMARY

One embodiment relates to an agricultural vehicle including a control system to control slip of a tractive element. The control system includes processing circuitry configured to obtain an indication of a priority operating parameter from a plurality of operating parameters of the agricultural vehicle. The control system is configured to, responsive to a first slip amount of the tractive element exceeding a threshold, perform an adjustment to at least one non-priority operating parameter from the plurality of operating parameters of the agricultural vehicle; operate the agricultural vehicle according to the adjustment to the at least one non-priority operating parameter; responsive to a second slip amount exceeding the threshold while operating the agricultural vehicle according to the adjustment to the at least one of the plurality of operating parameters, perform an adjustment to the priority operating parameter or a second non-priority operating parameter from the plurality of operating parameters; and operate the agricultural vehicle according to the adjustment to the priority operating parameter or the second non-priority operating parameter from the plurality of operating parameters.

In some embodiments, the agricultural vehicle obtains the indication of the priority operating parameter by receiving a user input from an operator interface of the control system, the priority operating parameter including one of an implement depth, a vehicle ground speed, an implement load, and a vehicle load.

In some embodiments the plurality of operating parameters include a steering angle, a braking force, a differential lock position, a four-wheel drive engagement, an engine speed, a transmission gear setting, a power take-off speed, an implement depth, a vehicle ground speed, an implement load, and a vehicle load.

In some embodiments, the control system is further configured to obtain an operating parameter data, obtain a corresponding location data in relation to the operating parameter data; and record the operating parameter data and the corresponding location data.

In some embodiments, the control system is further configured, by the processing circuitry, to employ machine learning to perform the adjustment to the at least one non-priority operating parameter from the plurality of operating parameters of the agricultural vehicle in accordance with the operating parameter data and the corresponding location data recorded by the agricultural vehicle.

In some embodiments, the agricultural vehicle is one of a plurality of agricultural vehicles in a fleet, wherein the plurality of agricultural vehicles have access to the operating parameter data and the corresponding location data recorded by the agricultural vehicle.

In some embodiments, the agricultural vehicle includes a vision system including at least one camera configured to produce an image data of an area proximate the agricultural vehicle. The control system is further configured to provide the image data to at least one of an obstacle identifier configured to identify a ground condition in a path of the agricultural vehicle in the image data, an obstacle detection manager configured to detect a slip condition or object in the path of the agricultural vehicle, and an obstacle avoidance manager configured to employ machine learning to preemptively perform the adjustment to the at least one non-priority operating parameter from the plurality of operating parameters to avoid the slip condition.

Another embodiment relates to a control system of an agricultural vehicle to control slip of a tractive element of an agricultural vehicle. The control system includes processing circuitry configured to obtain an indication of a priority operating parameter from a plurality of operating parameters of the agricultural vehicle. The processing circuitry further configured to, responsive to a first slip amount of the tractive element exceeding a threshold, perform an adjustment to at least one non-priority operating parameter from the plurality of operating parameters of the agricultural vehicle. The processing circuitry further configured to operate the agricultural vehicle according to the adjustment to the at least one non-priority operating parameter. The processing circuitry further configured to, responsive to a second slip amount exceeding the threshold while operating the agricultural vehicle according to the adjustment to the at least one of the plurality of operating parameters, perform an adjustment to the priority operating parameter or a second non-priority operating parameter from the plurality of operating parameters. The processing circuitry further configured to operate the agricultural vehicle according to the adjustment to the priority operating parameter or the second non-priority operating parameter from the plurality of operating parameters.

In some embodiments, the control system includes an operator interface for obtaining the indication of the priority operating parameter. The operator interface is configured to receive a user input of the indication of the priority operating parameter, the priority operating parameter including one of an implement depth, a vehicle ground speed, an implement load, and a vehicle load.

In some embodiments, the plurality of operating parameters includes a steering angle, a braking force, a differential lock position, a four-wheel drive engagement, an engine speed, a transmission gear setting, a power take-off speed, an implement depth, a vehicle ground speed, an implement load, and a vehicle load.

In some embodiments, the control system is further configured to obtain an operating parameter data, obtain a corresponding location data in relation to the operating parameter data, and record the operating parameter data and the corresponding location data.

In some embodiments, the control system is further configured to employ machine learning to perform the adjustment to the at least one non-priority operating parameter from the plurality of operating parameters of the agricultural vehicle in accordance with the operating parameter data and the corresponding location data recorded by the agricultural vehicle.

In some embodiments, the control system includes a vision system including at least one camera configured to produce an image data of an area proximate the agricultural vehicle. In some embodiments, the control system is configured to provide the image data to at least one of an obstacle detection manager configured to identify a ground condition in a path of the agricultural vehicle in the image data, an obstacle detection manager configured to detect a slip condition in the path of the agricultural vehicle, and an obstacle avoidance manager configured to employ machine learning to preemptively determine a needed adjustment to the at least one non-priority operating parameter from the plurality of operating parameters to avoid the slip condition. In some embodiments, the control system performs the needed adjustment to the at least one non-priority operating parameter from the plurality of operating parameters to avoid the slip condition.

Still another embodiment relates to a method to control slip of a tractive element of an agricultural vehicle. The method includes obtaining an indication of a priority operating parameter from a plurality of operating parameters of the agricultural vehicle. The method also includes responding to a first slip amount of the tractive element exceeding a threshold. The method also includes performing an adjustment to at least one non-priority operating parameter from the plurality of operating parameters of the agricultural vehicle. The method also includes operating the agricultural vehicle according to the adjustment to the at least one non-priority operating parameter. The method also includes responding to a second slip amount exceeding the threshold while operating the agricultural vehicle according to the adjustment to the at least one of the plurality of operating parameters. The method also includes performing an adjustment to the priority operating parameter or a second non-priority operating parameter from the plurality of operating parameters. The method also includes operating the agricultural vehicle according to the adjustment to the priority operating parameter or the second non-priority operating parameter from the plurality of operating parameters.

In some embodiments, the method also includes an operator interface for obtaining the indication of the priority operating parameter. The operator interface is configured to receive a user input of the indication of the priority operating parameter. The priority operating parameter includes one of an implement depth, a vehicle ground speed, an implement load, and a vehicle load.

The method of claim 14, wherein the plurality of operating parameters includes a steering angle, a braking force, a differential lock position, a four-wheel drive engagement, an engine speed, a transmission gear setting, a power take-off speed, an implement depth, a vehicle ground speed, an implement load, and a vehicle load.

In some embodiments, the method also includes obtaining an operating parameter data, obtaining a corresponding location data in relation to the operating parameter data, and recording the operating parameter data and the corresponding location data.

In some embodiments, the method includes employing machine learning to perform the adjustment to the at least one non-priority operating parameter from the plurality of operating parameters of the agricultural vehicle in accordance with the operating parameter data and the corresponding location data recorded by the agricultural vehicle.

In some embodiments, the method includes providing an image data, produced by a vision system including at least one camera, to at least one of an obstacle identifier configured to identify a ground condition or obstacle in a path of the agricultural vehicle in the image data, an obstacle detection manager configured to detect a slip condition in the path of the agricultural vehicle, and an obstacle avoidance manager configured to employ machine learning to preemptively determine a needed adjustment to the at least one non-priority operating parameter from the plurality of operating parameters to avoid the slip condition.

In some embodiments, the method includes performing the adjustment to the at least one non-priority operating parameter from the plurality of operating parameters to avoid the slip condition.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

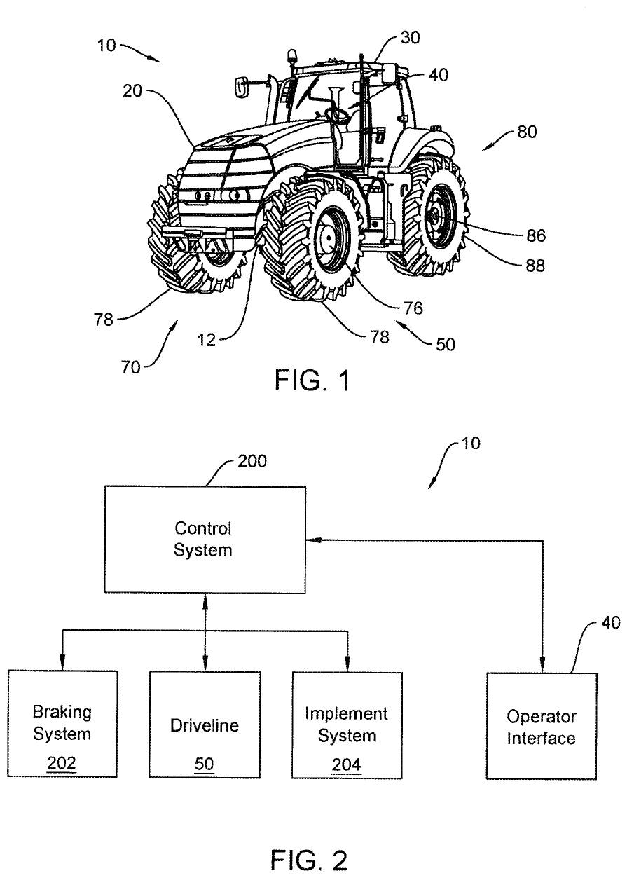

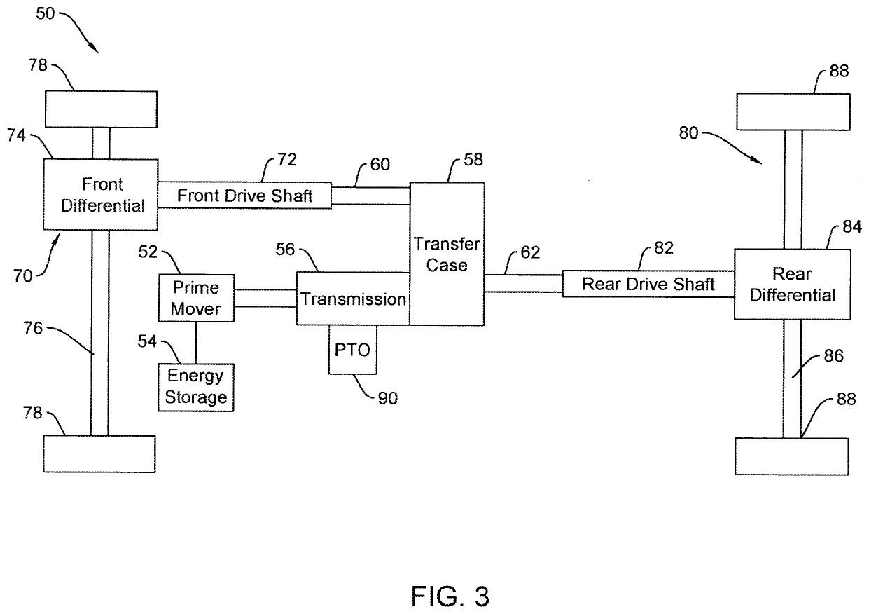

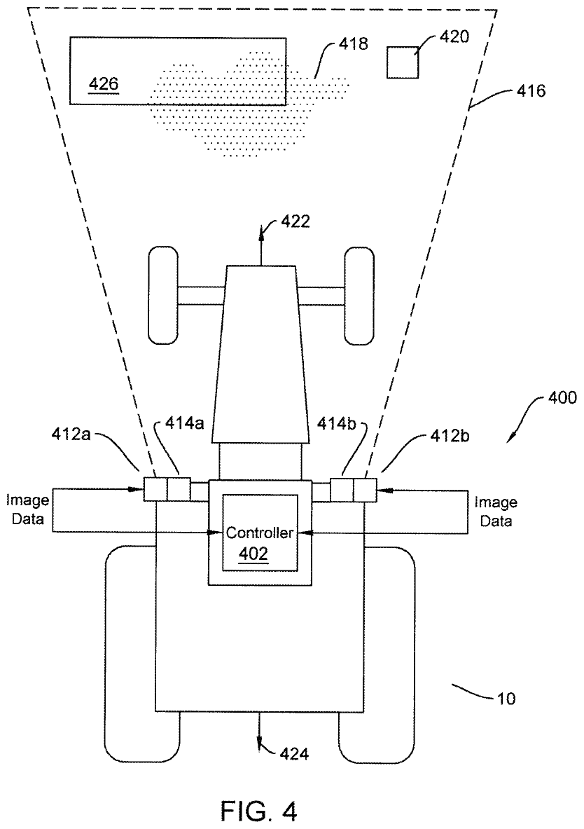

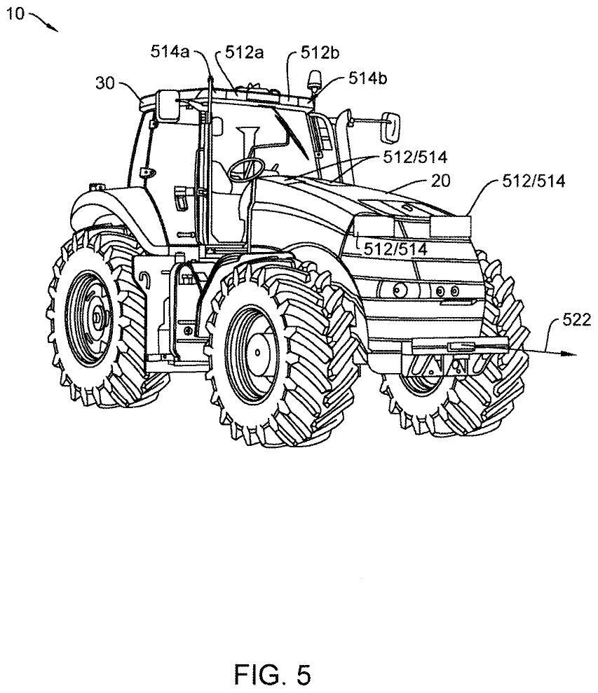

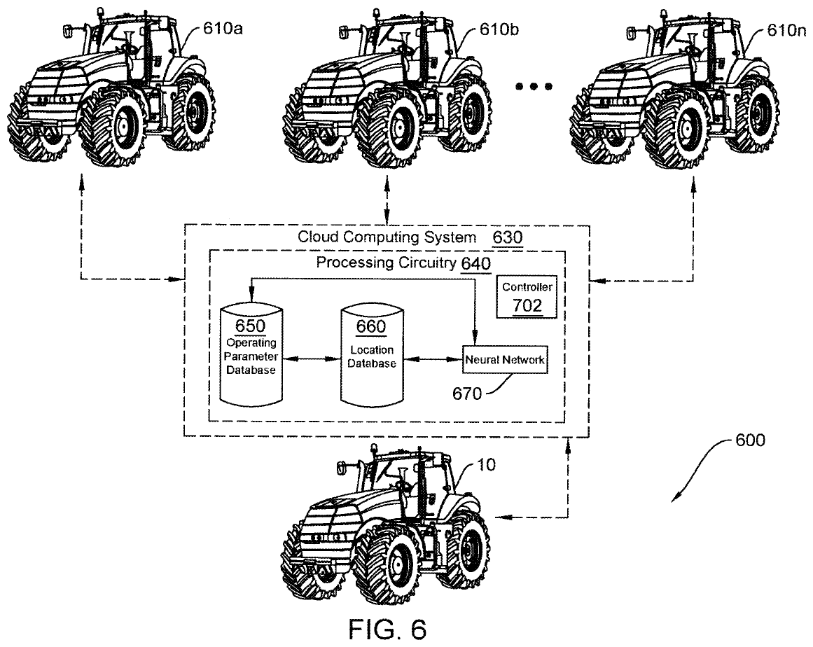

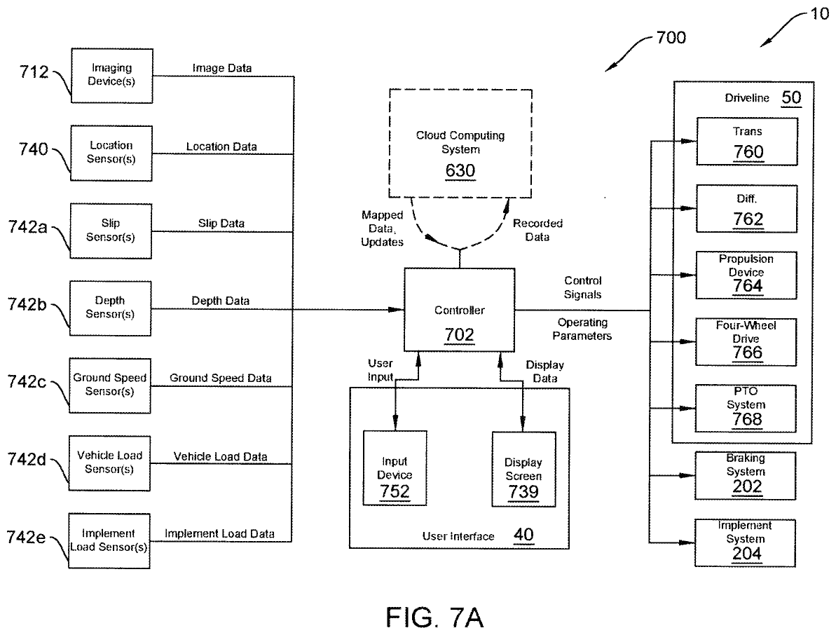

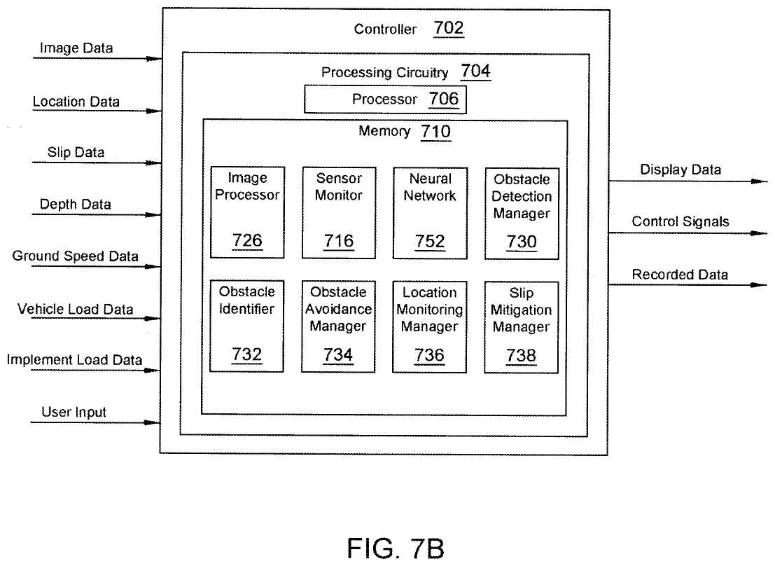

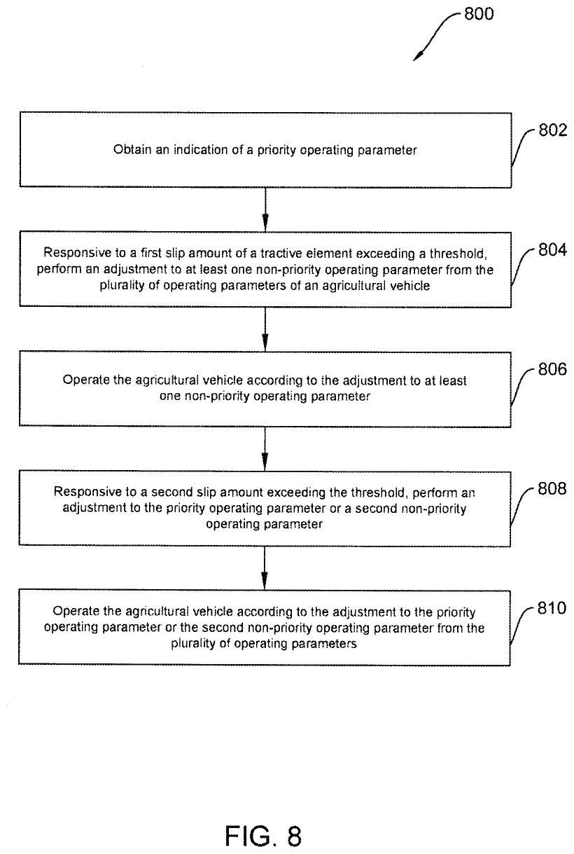

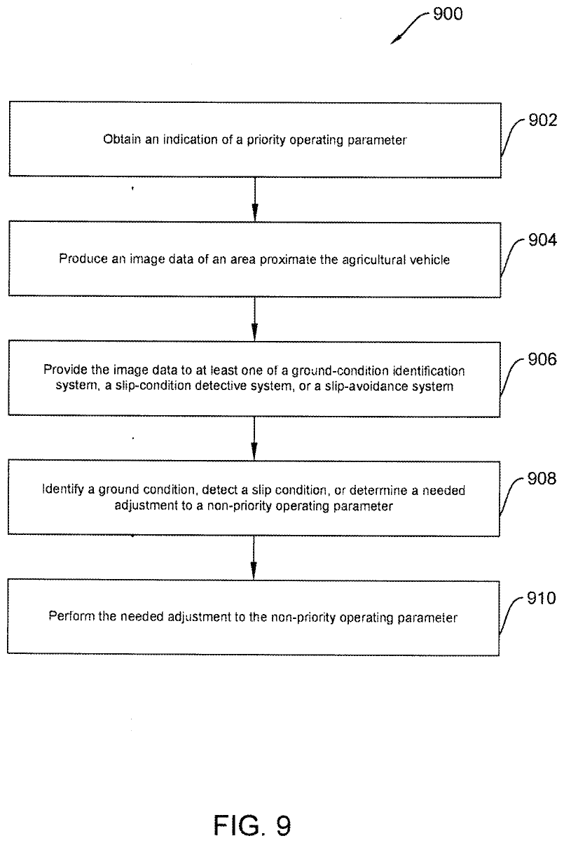

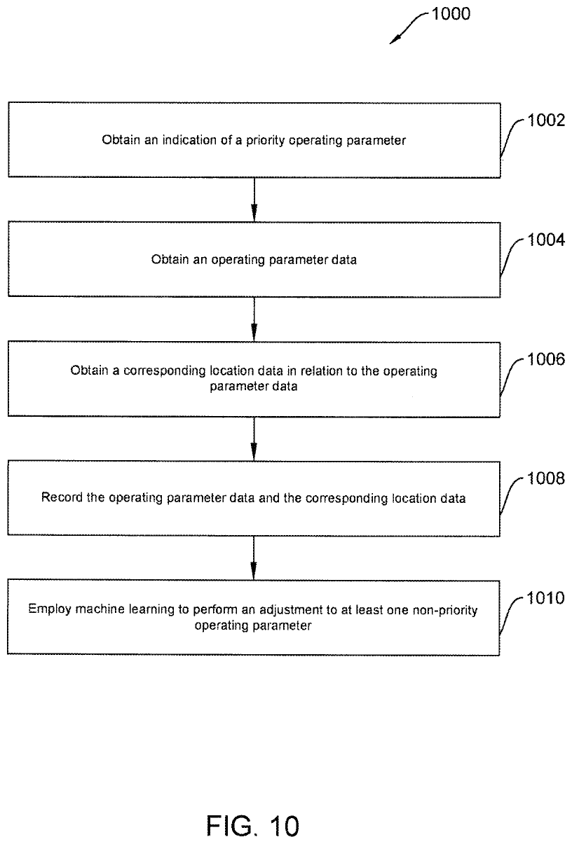

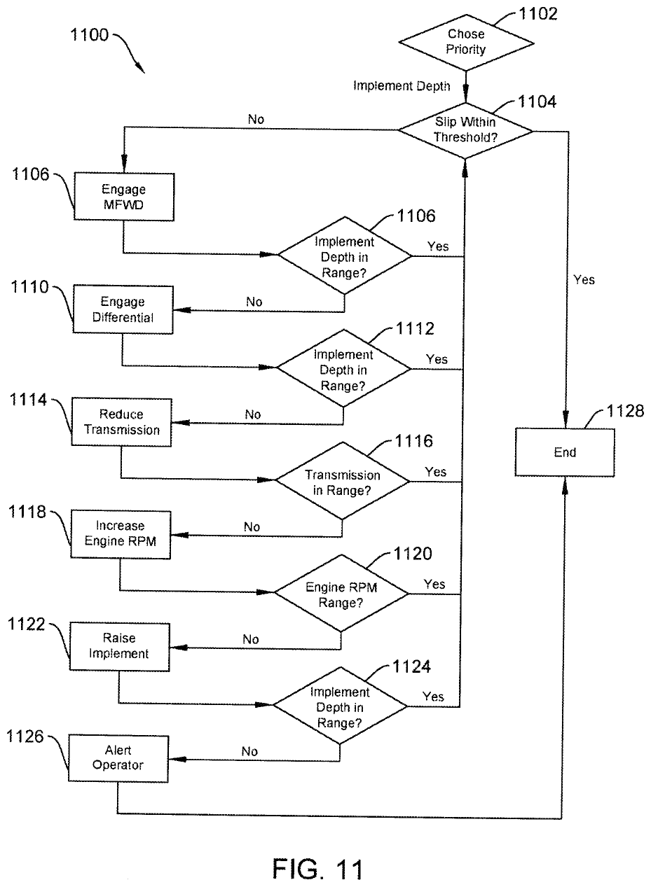

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 202, coupled to one or more components of the driveline 50 to facilitate selectively braking the one or more components of the driveline 50; an implement system, shown as implement system 204, coupled to one or more components of the drivetrain or body 20 to operate implements or machinery coupled to the vehicle 10; and a vehicle control system, shown as control system 200, coupled to the operator interface 40, the driveline 50, the implement system 204, and the braking system 202. In other embodiments, the vehicle 10 includes more or fewer components.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes an implement system 204 which may include one or more attached implements and/or trailed implements as such as a front mounted mower, a rear mounted mower, a trailed mower, a tedder, a rake, a baler, a plough, a cultivator, a rotavator, a tiller, a harvester, and/or another type of attached implement or trailed implement. The implements of implement system 204 may couple to the front or rear of vehicle 10 through various means, including, but not limited to, hydraulic hoses, electrical wires, PTO connection, three-point hitch, ball hitch, front forks, etc.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, an LED display, a speedometer, gauges, warning lights, etc. The one or more input device may be or include a steering wheel, a joystick, buttons, switches, knobs, levers, an accelerator pedal, an accelerator lever, a plurality of brake pedals, etc.

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, a mechanical front-wheel drive, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle). In some embodiments, the driveline includes a mechanical front-wheel drive assembly (“MFWD”) in which the prime mover 52 is mechanically coupled to an axle disposed between the front tractive elements 78. A mechanical front-wheel drive assembly may be used when the vehicle has rear tractive element 88 of a different size than the front tractive elements 78.

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 202 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 202 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Image System

Referring to FIGS. 4-5, the vehicle 10 can be equipped with an imaging system 400 (e.g., a detection system, a radar system, an awareness system, etc.) that is configured to monitor an environment or area surrounding (e.g., in front of, behind, on the sides of, etc.) the vehicle 10 and detect objects within the environment or area surrounding the vehicle 10. In some embodiments, the imaging system 400 is configured to obtain image data regarding a field of view 416 that is in front of the vehicle 10 as the vehicle 10 translates in a forward direction 422. In some embodiments, the imaging system 400 is also configured to monitor an area rearwards of the vehicle 10 or on the sides of the vehicle 10 in order to detect objects behind the vehicle 10 when the vehicle 10 transports in a rearwards direction 424 or makes turns.

The imaging system 400 includes one or more cameras 412a and 412b that are disposed on the vehicle 10 and are oriented such that the cameras 412 obtain image data (e.g., using visible light) of the field of view 416. The imaging system 400 also includes a controller 402 that is configured to obtain the image data from the cameras 412. The imaging system 400 may also include one or more radar transmitters/receivers, shown as radar transceivers 414a and 414b. The radar transceivers 414 are configured to emit radio waves about the field of view 416 in order to detect the object 420. The radar transceivers 414 receive responsive or reflected radio waves and generate data indicative of distance, angle, and radial velocity of the object 420. In some embodiments, the radar transceiver 414 are three-dimensional (3D) radar transceivers that are configured to determine position and extension of the object 420 in three dimensions or directions as well as the ground condition 426. The controller 402 is configured to obtain the radar data from the radar transceivers 414 and use the image data and the radar data to generate imagery of the field of view 416 that uses both image data and the radar data.

### Cloud Computing System

Referring to FIG. 6, a system 600 for obtaining, transmitting, and storing operating parameter data and location data is shown, according to some embodiments. In some embodiments, system 600 includes a fleet of n vehicles 610a-610n that are configured to obtain operating parameter data during operation, transmit the obtained operating parameter data to a cloud computing system 630, and/or record the operating parameter data in a database (e.g., operating parameter database 650). Vehicles 610a-610n may obtain the operating parameter through any suitable means, as described in greater detail in FIG. 7. In some embodiments, vehicles 610a-610n may transmit the obtained operating parameter data to the cloud computing system 630 through a communication link between the vehicles 610a-610n and the cloud computing system 630. According to some embodiments, the communication link may be wireless. The wireless transmission may occur by way of any of several wireless communication protocols, including, but not limited to, cellular, Wi-Fi, Bluetooth, Zigbee, Z-Wave, Thread, etc.

In some embodiments, system 600 includes a fleet of n vehicles 610a-610n that are configured to obtain location data during operation, transmit the obtained location data to a cloud computing system 630, and/or record the location data in a database (e.g., location database 660). Vehicles 610a-610n may obtain the operating parameter through any suitable means, as described in greater detail in FIG. 7. In some embodiments, vehicles 610a-610n may transmit the obtained location data to the cloud computing system 630 through a communication link between the vehicles 610a-610n and the cloud computing system 630. According to some embodiments, the communication link may be wireless. The wireless transmission may occur by way of any of several wireless communication protocols, including, but not limited to, cellular, Wi-Fi, Bluetooth, Zigbee, Z-Wave, Thread, etc.

According to some embodiments, cloud computing system 630 includes processing circuitry 640, operating parameter database 650, location database 660, and/or neural network 670. Processing circuitry 640 may include an ASIC, one or more FPGAs, a DSP, circuits containing one or more processing components, circuitry for supporting a microprocessor, a group of processing components, or other suitable electronic processing components. In some embodiments, processing circuitry 640 is configured to execute computer code stored in memory to facilitate the activities described herein. Memory may be any volatile or non-volatile computer-readable storage medium capable of storing data or computer code relating to the activities described herein. According to an exemplary embodiment, memory includes computer code modules (e.g., executable code, object code, source code, script code, machine code, etc.) configured for execution by processing circuitry 640. In some embodiments, cloud computing system 630 may represent a collection of processing devices (e.g., servers, data centers, etc.). In such cases, processing circuitry 640 represents the collective processors of the devices, and memory represents the collective storage devices of the devices.

In some embodiments, vehicle 10 is a member of the fleet of vehicles 610a-610n. In such embodiments, vehicle 10 may be configured to obtain operating parameter data and corresponding location data during operation, transmit the obtained operating parameter data and corresponding location data to a cloud computing system 630, and/or record the operating parameter data in a database (e.g., operating parameter database 650 and/or location database 660), as described herein.

In some embodiments, the controller 702, as shown in FIGS. 7A-7B, is in cloud computing system 630. In such embodiments, the functions of controller 702 may be executed in the cloud and the outputted control signals may be transmitted wirelessly to the vehicles 10, 610a-n

### Slip Control System

Referring to FIGS. 7A-7B, a control system 700 for intelligently adjusting control or operation of the driveline 50 in order to mitigate a slip condition while retaining desired functionality of the driveline 50 includes a controller 702. In some embodiments, control system 700 is an implementation of control system 200 of FIG. 2.

The controller 702 includes a circuit, shown as processing circuitry 704, a processor, shown as processor 706, and memory, shown as memory 710, according to an exemplary embodiment. Controller 702 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 7, controller 702 includes the processing circuitry 704 and memory 710. Processing circuitry 704 may include an ASIC, one or more FPGAs, a DSP, circuits containing one or more processing components, circuitry for supporting a microprocessor, a group of processing components, or other suitable electronic processing components. In some embodiments, processing circuitry 704 is configured to execute computer code stored in memory 710 to facilitate the activities described herein. Memory 710 may be any volatile or non-volatile computer-readable storage medium capable of storing data or computer code relating to the activities described herein. According to an exemplary embodiment, memory 710 includes computer code modules (e.g., executable code, object code, source code, script code, machine code, etc.) configured for execution by processing circuitry 704. In some embodiments, controller 702 may represent a collection of processing devices (e.g., servers, data centers, etc.). In such cases, processing circuitry 704 represents the collective processors of the devices, and memory 710 represents the collective storage devices of the devices.

The controller 702 is configured to obtain the image data from the imaging device 712. The imaging device 712 may include any suitable device to gather image data, including, but not limited to, cameras, LIDAR, radar, thermal imaging device, etc. The image data may indicate visual or visible light data of the field of view 416 of the vehicle 10. The image data may indicate multiple points or clusters of point data that indicate one or more objects 420 or ground conditions 426 in the field of view 416 or the area surrounding the vehicle 10. The controller 702 may receive the image data from a communications line, a wireless communications link, and a controller area network (CAN) bus of the vehicle 10, etc. In some embodiments, the memory 710 includes an image processor 726.

The image processor 726 may obtain the image data from the cameras 512 and perform an image analysis or generation technique in order to generate an image model of the field of view 416 of the vehicle 10. In some embodiments, the image processor 726 is configured to use the image data from multiple of the cameras 512 in order to generate a three-dimensional visual model (e.g., a CAD model) of the environment of the vehicle 10. In some embodiments, the image model is a graphical representation of objects or environment of the vehicle 10 that can be accurately distinguished using the image data. The image processor 726 may use machine learning or artificial intelligence (e.g., a generative adversarial network) and can use corresponding images from different perspectives in order to determine depth of the environment of the vehicle 10 (e.g., in the field of view 416). In some embodiments, the image processor 726 is configured to perform a reconstruction technique or process to generate 3D model data of the environment or area surrounding the vehicle 10 based on multiple two-dimensional (2D) images obtained by the cameras 512. In some embodiments, the cameras 512 include an array of cameras or one or more cameras 512 having wide angle lenses so that reconstruction can be performed using the image data by the image processor 726. In some embodiments, the image processor 726 is configured to perform a projective reconstruction technique without any a priori information. The image processor 726 may perform a stratification technique to generate 3D Euclidean geometry of the environment or area surrounding the vehicle 10. In some embodiments, the image processor 726 also uses known orientations and angles of the cameras 512 corresponding to different views. The image processor 726 may also perform a surface rendering technique with texturing using the image data in order to generate the image model. In some embodiments, the image processor 726 also performs a filtering technique in order to mitigate or reduce dust or particulate matter presence in the image data. In some embodiments, radar data is used to validate the results of the image processor 726.

In some embodiments, the image processor 726 is configured to obtain multiple types of data (e.g., visual data, radar data, thermal imaging data, LIDAR data, etc.) and blend or combine (e.g., overlay) the multiple types of data to provide a hybrid image. In some embodiments, the image processor 726 is configured to obtain the image data from the cameras 512 and insert or overlay a visual representation of radar data (e.g., 3D radar data) onto the image data to generate the hybrid image. The radar data can be visually represented by phantom lines, wire models, highlighted lines, a glowing object, dashed lines, red lines, brightly colored geometrical shapes, etc. The hybrid image includes both the image data as obtained from the cameras 512 as well as radar data from the radar transceivers 514, rendered over the image data in a manner to increase perceptibility or visibility of the object.

The image processor 726 is configured to provide, through a neural network 752, the updated image model to an obstacle detection manager 730, an obstacle identifier 732, an obstacle avoidance manager 734, location monitoring manager 736, a slip mitigation manager 739 and/or a display 739 (e.g., a display screen of the operator interface 40). The image processor 726 is also configured to provide, through a neural network 752, the hybrid image to any of the obstacle detection manager 730, the obstacle identifier 732, the obstacle avoidance manager 734, the location monitoring manager 736, the slip mitigation manager 738, and/or the display 739. In some embodiments, the functionality of the obstacle detection manager 730, the obstacle identifier 732, the obstacle avoidance manager 734, the slip mitigation manager 738, and/or the location monitoring manager 736 are performed by the controller 702 or by other similar controllers or processing circuitry of the vehicle 10. In some embodiments, the obstacle detection manager 730, the obstacle identifier 732, the obstacle avoidance manager 734, the location monitoring manager 736, and/or the slip mitigation manager 738 are configured to provide their outputs to the display 739 and/or to the control system 200 for use in adjusting operation or control of the vehicle 10. In some embodiments, the obstacle detection manager 730, the obstacle identifier 732, the obstacle avoidance manager 734, the location monitoring manager, and/or the slip mitigation manager 738 are configured to provide their outputs to a control system for use in adjusting operation or control of the vehicle 10. In some embodiments, one or more of the obstacle detection manager 730, the obstacle identifier 732, and/or the obstacle avoidance manager 734, the location monitoring manager 736, and/or the slip mitigation manager 738 are implemented on a cloud computing system or a server, or one or more processes or functionality thereof are implemented or offloaded to a server.

The display 739 can be positioned within the cab 30 of the vehicle 10 and may be a touchscreen, a light emitting diode (LED) screen, a liquid crystal display (LCD) screen, etc. In some embodiments, the display 739 includes or is configured to communicate with an augmented reality or virtual reality headset or head-wearable device for the operator of the vehicle 10. The display 739 is configured to visually and/or immersively present the updated image model or the hybrid image to the operator of the vehicle 10. In some embodiments, the display 739 is a remote device (e.g., at a control center) if the vehicle 10 is an autonomous device or is a remotely controlled device. In some embodiments, the display 739 is a portion of a windshield of the cab 30 of the vehicle 10, and the updated image model, the hybrid image, or portions of the updated image model or the hybrid image that are obstructed from the view of the operator due to dust are superimposed onto the windshield in an augmented reality manner. The controller 702 may also be configured to obtain an indication of a priority operating parameter 750 from a user input 752 that is provided by a user or operator of the vehicle 10 via operator interface 40. The user input may be displayed on the display 739. Alternatively, the priority operating parameter may be automatically indicated by a remote operating parameter database 610 that is communicatively coupled with the controller 702. The priority operating parameter 750 may be any suitable operating parameter, including operating parameters for a transmission 760 (e.g., gear selection), a differential locking system 762 (e.g., engagement), a prime mover 764 (e.g., a speed), mechanical front-wheel drive system 766 (e.g., engagement), a power-take-off 768 (e.g., engagement or speed), a braking system 202 (e.g., braking pressure), vehicle or implement operating load, an implement depth, or a ground speed. In an exemplary embodiment, the priority operating parameter 750 is either the vehicle 10 ground speed, an implement depth, a vehicle operating load, or an implement operating load. Once a user, or operator, selects a priority operating parameter, the remaining operating parameters may be categorized by the controller 702 as non-priority or lower priority operating parameters that can be a first selection for modification to mitigate a slip condition before adjusting, modifying, or changing the priority operating parameter. The indication of the priority operating parameter may be recorded and stored in the memory 710 of the controller 702. Alternatively, the indication of the priority operating parameter may be recorded and stored in the remote operating parameter database 650, as shown in FIG. 7A.

Slip sensor 742a may provide slip sensor data to controller 702 through a communication link between slip sensor 742a and the sensor monitor 716. The communication link between slip sensor 742a and the sensor monitor 716 may be wired or wireless, according to some embodiments. Slip sensor 742a may also provide the slip sensor data to a remote server hosting the operating parameter database 650. In some embodiments, slip sensor 742a is configured to measure the slip of vehicle 10. Slip sensor 742a may measure the slip of vehicle through the use of a proximity sensor on the transmission to determine a theoretical speed of vehicle 10. In some embodiments, the theoretical speed of vehicle 10 can be determined using the diameter of the front tractive element 78, the speed of the transmission, and the ratio of gear size to tractive element size. Once the theoretical speed of vehicle 10 is calculated, it is compared to the actual speed of vehicle 10. The actual speed of vehicle 10 may be determined, according to some embodiments, by measuring the movement over time of vehicle 10 by location sensor 740. In other embodiments, the actual speed of the vehicle 10 may be calculated through collected data from radar transceivers 414. This ratio of theoretical speed to actual speed may be mapped to a slip value and compared to a slip threshold. This mapping and comparing may occur in the neural network 752 of the controller 702 or on a remote server.

Depth sensor 742b may provide depth sensor data to controller 702 through a communication link between depth sensor 742b and the sensor monitor 716. The communication link between depth sensor 742b and the sensor monitor 716 may be wired or wireless, according to some embodiments. Depth sensor 742b may also provide the depth sensor data to a remote server hosting the operating parameter database 650. In some embodiments, depth sensor 742b is configured to measure the depth of engagement of an implement system 204 with the ground. Depth sensor 742b may measure the depth of engagement by measuring the position of the implement relative to a known object (e.g., the vehicle 10, the surface of the ground, etc.). Depth sensor 742 may also use potentiometers or cam shafts to measure the position of the implement relative to a known object. Potentiometers or cam shafts may also be used to measure the relative position of levers within the cab of vehicle 10, which can then be mapped to an implement depth of engagement with the ground. Various other embodiments may be used to determine the depth of engagement between the implement and the ground.

Ground speed sensor 742c may provide ground speed sensor data to controller 702 through a communication link between ground speed sensor 742c and the sensor monitor 716. The communication link between ground speed sensor 742c and the sensor monitor 716 may be wired or wireless, according to some embodiments. Ground speed sensor 742c may also provide the ground sensor data to a remote server hosting the operating parameter database 650. In some embodiments, the ground speed sensor 742c is configured to measure the actual ground speed of vehicle 10. Ground speed sensor 742c may measure the actual ground speed of vehicle 10 by using the location data from location sensor 740 to determine the distance traveled over a defined time period. In another embodiment, the ground speed sensor 742c may use a ground speed radar to determine the actual ground speed of vehicle 10. Various other embodiments may exist to determine the ground speed of vehicle 10.

Vehicle load sensor 742d may provide vehicle load sensor data to controller 702 through a communication link between vehicle load sensor 742d and the sensor monitor 716. The communication link between vehicle load sensor 742d and the sensor monitor 716 may be wired or wireless, according to some embodiments. Vehicle load sensor 742d may also provide the vehicle load sensor data to a remote server hosting the operating parameter database 650. In some embodiments, the vehicle load sensor 742d is configured to measure the load on the vehicle (e.g., engine load, axle load, etc.). Vehicle load sensor 742d may measure the load on vehicle 10 through the use of shear pins, load cells, engine speed, engine temperature, stress and strain gauges, or any other suitable means to measure vehicle load.

Implement load sensor 742e may provide implement load sensor data to controller 702 through a communication link between implement load sensor 742e and the sensor monitor 716. The communication link between implement load sensor 742e and the sensor monitor 716 may be wired or wireless, according to some embodiments. Implement load sensor 742e may also provide the implement load sensor data to a remote server hosting the operating parameter database 650. In some embodiments, the implement load sensor 742e is configured to measure the load on an implement coupled to vehicle 10. Implement load sensor 742e may measure the load on the implement coupled to vehicle 10 through the use of shear pins, load cells, engine speed, engine temperature, stress and strain gauges, or any other suitable means to measure vehicle load.

Location sensor 740 may provide implement load sensor data to controller 702 through a communication link between implement load sensor 742e and the sensor monitor 716. The communication link between implement load sensor 742e and the sensor monitor 716 may be wired or wireless, according to some embodiments. Location sensor 740 may also provide the location data to a remote server hosting a location database 660. The location sensor 740 may be any suitable device to gather location data including, but not limited to a global positioning system (“GPS”).

Location sensor 740 may also be used in an automatic guidance system of vehicle 10. In some embodiments, vehicle 10 operates without a human operator controlling the vehicle 10. In such embodiments, location sensor 740 may provide location data to the sensor monitor 716 which can then be used by the obstacle detection manager 730, the obstacle identifier 732, the obstacle avoidance manager 734, and the location monitoring manager 736, and/or the slip mitigation manager 738 to operate vehicle 10 without human input. The automatic guidance system may comprise automatically controlling steering angle, braking pressure, transmission speed, differential engagement, four-wheel drive engagement, a power take-off engagement, implement depth, etc. through the use of control system 200. A machine learning model (e.g., neural network 752) may be used to train the automatic guidance system using location data from location database 660 and operating parameter data from operating parameter database 650. The machine learning model may be housed locally in controller 702 or remotely in a remote-hosted server.

In other embodiments, sensors 742a-e may monitor at least one of the operating parameters of the vehicle 10. These operating parameters may include, but are not limited to, operating parameters for a transmission (e.g., gear selection), a differential locking system (e.g., engagement), a prime mover (e.g., a speed), mechanical front-wheel drive system (e.g., engagement), a power-take-off (e.g., engagement or speed), vehicle or implement operating load, an implement depth, or a ground speed.

In some embodiments, the data received by sensor monitor 716 and the priority operating parameter 750 are provided to a neural network 752 to perform an obstacle detection manager 730, an obstacle identifier 732, an obstacle avoidance manager 734, a location monitoring manager 736, and/or a slip mitigation manager 738. In other embodiments, the neural network can transmit the sensor data to the display 739 of the operator interface 40. In other embodiments, the data received by sensor monitor 716 and the priority operating parameter 750 are provided directly to the obstacle detection manager 730, the obstacle identifier 732, the obstacle avoidance manager 734, the location monitoring manager 736, the slip mitigation manager 738, and/or the display 739.

In some embodiments, the neural network 752 may use inputs from sensors 742a-e to learn how an operator responds to varying slip values. In some embodiments, the obstacle avoidance manager 734, the location monitoring manager 736, and the slip mitigation manager 738 use the learned behavior of the operator to adjust non-priority operating parameters through control system 200 to mirror an operator's actions. In some embodiments, the neural network 752 may also utilize location data from location database 660 and operating parameter data from operating parameter database 650 to learn how an operator (or a fleet of operators) respond to a slip condition. In these embodiments, the neural network 752 may automatically make adjustments to non-priority or priority operating parameters preemptively to avoid (or mitigate) known slip conditions through the use of the location monitoring manager 736 which in turns sends a data signal to control system 200 to send the control signal to the non-priority operating parameter. In some embodiments, the neural network 752 first or primarily adjusts all non-priority operating parameters before adjusting the priority operating parameter.

The obstacle detection manager 730 can use the updated image model and/or the hybrid image model to perform an object detection and determine if an object is within a path of the vehicle 10 as the vehicle transports in a field or on a road (e.g., in an agricultural, or a transportation environment, respectively). The obstacle detection manager 730 may obtain the updated image model or the hybrid image, and based on a predicted or projected path of the vehicle 10, detect if an object 420 of or ground condition 426 is within the path of the vehicle 10. The obstacle detection manager 730 may be configured to operate a visual alert device or an aural alert device in order to notify the operator of the vehicle 10 regarding the detected object. In other embodiments, the obstacle detection manager 730 can use the updated image model and/or the hybrid image model to perform an object detection and determine if ground condition 426 is within a path of the vehicle 10 as the vehicle transports in a field or on a road (e.g., in an agricultural, or a transportation environment, respectively). In some embodiments, the ground condition 426 may result in the vehicle 10 entering into a slip condition exceeding an acceptable threshold.

The obstacle identifier 732 may use a database and an image recognition technique to determine or identify a type of object that is detected (e.g., by the obstacle detection manager 730) in the updated image model and/or the hybrid image. In some embodiments, the obstacle identifier 732 is configured to use a database of objects, animals, ground conditions etc., that may be encountered in an agricultural environment (e.g., trees, rocks, standing water, running water, divots, planted rows, people, animals, tree stumps, machinery, ditches, etc.). The obstacle identifier 732 may use a neural network or machine learning to implement the image recognition technique in order to match the detected objects, obstacles, or ground conditions to one of the objects, obstacles, or ground conditions of the database. The identification of the object(s) in the field of view 416 of the vehicle 10 can be provided to the display 739, and high priority or avoidance objects may be highlighted, callouts can be added to indicate the type of object identified, etc.

The obstacle avoidance manager 734 is configured to use the updated image model, the hybrid image, and/or the outputs of the obstacle detection manager 730 or the obstacle identifier 732 to determine a corrective measure or action to avoid a collision or slip condition between the vehicle 10 or the attached implement and the object or ground condition that is detected using the image data and/or the radar data. In some embodiments, the corrective measure or action includes braking, stopping, or slowing the vehicle 10. In some embodiments, the corrective measure or action includes adjusting a path (e.g., steering) of the vehicle 10 to avoid the obstacle. In some embodiments, the corrective measure or action includes honking a horn of the vehicle 10 to prompt an animal to move out of the way of the vehicle 10. In some embodiments, the corrective measure is lifting an attached implement to avoid a slip condition. In an exemplary embodiment, the corrective measure is adjusting a first non-priority operating parameter. The obstacle avoidance manager 734 may provide the corrective measure or action to the control system 200 so that the control system 200 can use the corrective measure or action to operate the driveline 50, the braking system 202, the implement system 204, or any other system or subsystem of the vehicle 10 to perform the corrective measure or action. In some embodiments, the obstacle avoidance manager 734 may adjust a non-priority operating parameter prior to adjusting the priority operating parameter 750. In some embodiments, the obstacle avoidance manager 734 will adjust all of the non-priority operating parameters prior to adjusting the priority operating parameter 750. The obstacle avoidance manager 734 may adjust the non-priority operating parameters one at a time, or may adjust multiple non-priority operating parameters at once, or may adjust all of the non-priority operating parameters at once. The obstacle avoidance manager 734 may use a neural network (either locally or remotely) to determine the optimal order of adjustments to make to avoid a collision or slip condition. For example, the system may optimize for fuel efficiency, likelihood of avoidance of the slip condition or collision, minimum number of adjustments, etc.

The location monitoring manager 736 may use results of the obstacle detection manager 730 and/or the obstacle identifier 732 as well as geographic locations of the vehicle 10 collected from the location sensor 740 to learn the locations of specific objects or obstacles and ground conditions (e.g., trees, rocks, etc.) to generate a mapping for precautions. In some embodiments, the location monitoring manager 736 aggregates data from the vehicle 10 and/or vehicles 610-610n to provide the controller 702 with the mapping for future operation of the vehicle 10. Location monitoring manager 736 may collect location data with corresponding operating parameter data from location database 660 and operating parameter database 650, respectively. In this embodiment, the location monitoring manager 736 may map the location of known ground conditions that required adjustments to the operating parameters due to a slip condition.

In some embodiments, the location monitoring manager 736 may alert the operator of vehicle 10 of a known and upcoming slip condition. According to some embodiments, the alert may appear on the display 739 of operator interface 40. The alter may contain aural and visual cues to alert the operator's attention (e.g., activating a light, activating a warning alarm, providing a textual notification on the display 739, etc.). In some embodiments, the alert may provide predicted operating parameter adjustments that will be needed to avoid a slip condition. In some embodiments, the operator may use the alerts to make manual adjustments to the non-priority operating parameters. In other embodiments, the location monitoring manager 736 may automatically make the non-priority (or priority) operating parameter adjustments. In some embodiments, the operator may choose whether location monitoring manager 736 may automatically make adjustments or not by using the user input 741. Similarly, the operator, in some embodiments, may choose to allow or not allow the obstacle identifier 732 to automatically adjust the operating parameters. Similarly, the operator may choose to allow or not allow the slip mitigation manager 738 to automatically adjust the operating parameters.

In some embodiments, the location monitoring manager 736 uses sensor data from sensors 742a-742n to learn the location of specific ground conditions (e.g., ground condition 426) and generate a mapping for future preemptive operating parameter adjustments to avoid slip conditions or to avoid needing to adjust the priority operating parameter. For example, vehicle 10 (with an implement depth priority operating parameter 750) may encounter a slip condition that exceeds a threshold at point “A” when vehicle 10 traverses a stream while towing an implement (e.g., a plow). Using process 800 from FIG. 8, the vehicle's 10 mechanical front-wheel drive is engaged to reduce the slip condition while maintaining an implement depth. However, being unable to reduce the slip condition (and after adjusting all other relevant, non-priority operating parameters), vehicle 10 raises the implement depth (the priority operating parameter) to further reduce the slip condition. Location monitoring manager 736 may record the data from at least one of sensor 742a-e (e.g., mechanical front-wheel drive engagement sensor, differential lock engagement sensor, etc.) with corresponding location data obtained from location sensor 740. Location monitoring manager 736 may then use the location data with the associated sensor data from sensor 742a-e to generate a mapping to preemptively adjust vehicle's 10 non-priority operating parameters (e.g., the vehicle's 10 mechanical front-wheel drive) when vehicle 10 next passes through point “A” to preemptively avoid entering a slip condition.

The slip mitigation manager 738 may be used to mitigate slip of vehicle 10 when the slip value received from slip sensor 742a exceeds a predetermined slip threshold. This slip threshold may be set by the operator of vehicle 10 through the use of user input 741 of operator interface 40. In other embodiments the operator may set the slip threshold remotely. In other embodiments the slip threshold may be saved in a database hosted remotely from vehicle 10. Upon slip sensor 742a measuring a slip value exceeding the slip threshold and transmitting that slip value to sensor monitor 716, the neural network 752 may receive the slip value from sensor monitor 716 and the priority operating parameter 750 to determine an adjustment to a non-priority operating parameter. The slip mitigation manager 738 may use this determination to send a data or control signal to control system 200 which in turn sends a control signal to the relevant subsystem adjust the non-priority operating parameter. In some embodiments, the nonpriority operating parameter may be any suitable operating parameter for a transmission 760 (e.g., gear selection), a differential locking system 762 (e.g., engagement), a prime mover 764 (e.g., a speed), mechanical front-wheel drive system 766 (e.g., engagement), a power-take-off 768 (e.g., engagement or speed), a braking system 202 (e.g., braking pressure, left or right braking, etc.), vehicle or implement operating load, an implement depth, or a ground speed.

In some embodiments, the location monitoring manager 736 and obstacle avoidance manager 734 will optimize the operating parameter adjustments distinctly from the slip mitigation manager 738. This is due to the needs of a vehicle in either preemptively adjusting operating parameters (such as in the case of the obstacle avoidance manager 734 and the location monitoring manager 736) or reactively adjusting operating parameters (such as in the case of the slip mitigation manager 738).

According to some embodiments, the operator may be able to engage or disengage the obstacle detection manager 730, the obstacle identifier 732, the obstacle avoidance manager 734, the location monitoring manager 736, and/or the slip mitigation manager 738. In some embodiments, engage or disengage can mean completely turn on or completely turn off. In other embodiments, engage or disengage can relate to turning on or off only the automatic adjustment of the operating parameters.

According to some embodiments, the obstacle detection manager 730, the obstacle identifier 732, the obstacle avoidance manager 734, the location monitoring manager 736, and/or the slip mitigation manager 738 may provide alerts to the operator of vehicle 10. These alerts may comprise aural, visual, and/or haptic alerts configured to capture the attention of the operator of vehicle 10 to alert the operator of an upcoming collision or slip condition (either actual or predicted). These alerts may be displayed on display 739 of the operator interface 40. In other embodiments the alerts may be displayed in a remote location. In other embodiments the alert can notify the operator of an upcoming collision or slip condition and prompt the operator to engage the obstacle detection manager 730, the obstacle identifier 732, the obstacle avoidance manager 734, the location monitoring manager 736, and/or the slip mitigation manager 738.

In some embodiments, the obstacle detection manager 730, the obstacle identifier 732, the obstacle avoidance manager 734, the location monitoring manager 736, and/or the slip mitigation manager 738 work together to preemptively avoid slip conditions and/or to reactively mitigate encountered slip conditions. In some embodiments, only one system is engaged while in other embodiments multiple systems may be engaged.

In some embodiments, when the priority operating parameter is vehicle load, the obstacle detection manager 730, the obstacle identifier 732, the obstacle avoidance manager 734, the location monitoring manager 736, and/or the slip mitigation manager 738 work together to preemptively and reactively maintain the load on the vehicle below the threshold loading. Vehicle load sensor 742d transmits a vehicle load value to sensor monitor 716. This load value is sent to neural network 752 (along with the priority operating parameter 750) to be sent to the systems 730-738. These systems 730-738 then determine either preemptively (e.g., the obstacle avoidance manager 734 or location monitoring manager 736) or reactively (e.g., slip mitigation manager 738) which operating parameters to adjust to maintain a vehicle loading below the threshold.

In some embodiments, when the priority operating parameter is implement load, the obstacle detection manager 730, the obstacle identifier 732, the obstacle avoidance manager 734, the location monitoring manager 736, and/or the slip mitigation manager 738 work together to preemptively and reactively maintain the load on the implement below the threshold loading. Implement load sensor 742e transmits an implement load value to sensor monitor 716. This load value is sent to neural network 752 (along with the priority operating parameter 750) to be sent to systems 730-738. These systems 730-738 then determine either preemptively (e.g., the obstacle avoidance manager 734 or location monitoring manager 736) or reactively (e.g., slip mitigation manager 738) which operating parameters to adjust to maintain an implement loading below the threshold.

It should be understood that the controller 702 may include a plurality of processors to execute the various models, managers, and identifiers as described above.

Referring to FIG. 8, a flow diagram of a process 800 for controlling the slip of a tractive element of an agricultural vehicle according to the steps 802-810. In some embodiments, the process 800 is performed by an operator of the agricultural vehicle. In other embodiments, the process 800 is performed autonomously by a controller utilizing a neural network and a machine learning model. The neural network may be housed locally on the agricultural vehicle or, alternatively, the neural network may be housed remotely and be in communication with the agricultural vehicle wirelessly through the use of various wireless communication protocols, including, but not limited to, Wi-Fi, cellular, Bluetooth, etc.

Process 800 includes obtaining an indication of a priority operating parameter 750 of the vehicle 10 (step 802), according to some embodiments. According to some embodiments, the priority operating parameter 750 can be obtained by the user input 741 of operator interface 40 through the use of various interactive elements of a graphical user interface displayed on display 739. In several embodiments, these interactive elements include radio buttons, sliders, checkboxes, text inputs, dials, etc. In other embodiments, the user may use physical controls as the user input 741. In some embodiments, the operator interface is housed within vehicle 10. In other embodiments, the operator interface is housed remotely of vehicle 10. User input 741 may come from a remote operator. In some embodiments, the user input may be obtained from an operating parameter database 650 housed remotely from vehicle 10 and based at least in part on a priority operating parameter of vehicles 610a-610n. In some embodiments, step 802 is performed by the controller 702.

Process 800 includes responding to a first slip amount of a tractive element exceeding a threshold, perform an adjustment to at least one non-priority operating parameter from the plurality of operating parameters of an agricultural vehicle (step 804), according to some embodiments. In some embodiments, upon receiving an indication from slip sensor 742a that the vehicle 10 has entered into a slip condition, the slip mitigation manager 738 sends a signal to control system 200 to adjust a non-priority operating parameter to decrease the amount of slip experienced by vehicle 10. Non-priority operating parameters may include steering angle, a braking force, a differential lock position, a four-wheel drive engagement, an engine speed, a transmission gear setting, a power take-off speed, an implement depth, or a vehicle ground speed.

Process 800 includes operating the agricultural vehicle according to the adjustment to the at least one non-priority operating parameter (step 806), according to some embodiments. Once the slip mitigation manager 738 sends the signal to control system 200 to adjust the non-priority operating parameter, the vehicle is operated with the non-priority operating parameter adjusted.

Process 800 includes responding to a second slip amount exceeding the threshold, performing an adjustment to the priority operating parameter or a second non-priority operating parameter (step 808), according to some embodiments. In some embodiments, upon receiving an indication from slip sensor 742a that the vehicle 10 is still in a slip condition, the slip mitigation manager 738 sends a control signal to control system 200 to adjust the priority operating parameter to decrease the amount of slip experienced by the vehicle 10. Once the signal from the slip mitigation manager 738 is received by control system 200, control system 200 sends the control signal to the priority operating parameter to make the adjustment. The priority operating parameter 750 may be defined by the operator through the user input 741 on operator interface 40. In other embodiments, the priority operating parameter 750 may be set remotely by using location data stored in location database 620 and/or operating parameter data store in operating parameter database 650.

Process 800 includes operating the agricultural vehicle according to the adjustment to the priority operating parameter or the second non-priority operating parameter from the plurality of operating parameters (step 810), according to some embodiments. In some embodiments, once the control system 200 has sent the control signal to the priority operating to make an adjustment, the vehicle is then operated with the adjustment to decrease slip.

Turning now to FIG. 11, an exemplary embodiment of the process 800 is shown. At option 1102, an operator of vehicle 10 selects a priority operating parameter from a list of operating parameters and selects an acceptable range for which the operating parameter may operate. The user selects implement depth as the priority parameter and begins operating the vehicle. At step 1104, the controller determines whether or not the vehicle is in a slip condition outside of an acceptable range, the acceptable range previously determined by the operator. If the slip is outside the acceptable range, the controller sends a control signal to engage the mechanical four-wheel drive at step 1106. At step 1108, the controller checks if the implement depth is in the acceptable range selected previously. If it is, the controller again checks to see if the slip is within the threshold at step 1104. If the depth is outside the acceptable range, the controller sends a control signal to engage the differential at step 1110. At step 1112, the controller checks if the implement depth is within the acceptable range. If yes, the process returns to step 1104. If not, the process continues to step 1114 to reduce the transmission. After reducing the transmission, the controller checks to see if the transmission is within an acceptable range. If yes, the process returns to step 1104. If not, the controller sends a control signal to increase the engine RPM at step 1118. The controller then checks if the engine RPM is within an acceptable range at step 1120. If yes, the process continues to step 1104. If not, the controller will finally adjust the priority parameter (the implement depth) by raising the implement at step 1122. The controller checks once again if the implement depth is within range at step 1124. If yes, the process continues to step 1104. If not, the controller sends a control signal to alert the operator to take control of the vehicle and the process ends. It should be understood that the various steps of process 1100 may be executed by any means described herein.

Referring to FIG. 9, a flow diagram of a process 900 for controlling the slip of a tractive element of an agricultural vehicle includes steps 902-910, according to some embodiments. In some embodiments, the process 900 is performed by the controller of the agricultural vehicle. In other embodiments, the process 900 is performed autonomously by a controller utilizing a neural network and a machine learning model. The neural network may be housed locally on the agricultural vehicle or, alternatively, the neural network may be housed remotely and be in communication with the agricultural vehicle wirelessly through the use of various wireless communication protocols, including, but not limited to, Wi-Fi, cellular, Bluetooth, etc.

Process 900 includes obtaining an indication of a priority operating parameter (step 902), according to some embodiment. In some embodiments, the priority operating parameter 750 can be obtained by the user input 741 of operator interface 40 through the use of various interactive elements of a graphical user interface displayed on display 739. In several embodiments, these interactive elements include radio buttons, sliders, checkboxes, text inputs, dials, etc. In other embodiments, the user may use physical controls as the user input 741. In some embodiments, the operator interface is housed within vehicle 10. In other embodiments, the operator interface is housed remotely of vehicle 10. User input 741 may come from a remote operator. In other embodiments, user input may come from an operating parameter database 650 housed remotely from vehicle 10 and based at least in part on a priority operating parameter of vehicles 610a-610n.

Process 900 includes producing an image data of an area proximate the agricultural vehicle (step 904), according to some embodiments. In some embodiments, image data may be produced from various data from the imaging devices 712. In some embodiments, the imaging devices are cameras, radar detectors, LIDAR, thermal imaging devices, etc. In some embodiments, the imaging devices are the imaging devices 712, the radar transceivers 414, or the cameras 412. In some embodiments, step 904 is performed by the controller 702 based on image data or signals obtained from the imaging devices 712 of the vehicle 10.

Process 900 includes providing the image data to at least one of an obstacle detection manager, an obstacle identifier, and/or an obstacle avoidance manager (step 906), according to some embodiments. In some embodiments, the image data is sent through a neural network 752 before being sent to the obstacle detection manager 730, the obstacle identifier 732, and/or the obstacle avoidance manager 734.

Process 900 includes identifying a ground condition, detecting a slip condition, and/or determining a needed adjustment to a non-priority operating parameter (step 908), according to some embodiments. In some embodiments, the obstacle detection manager 730 detects an obstacle (e.g., an object 420 or ground condition 426) in a predicted path of the vehicle 10. In some embodiments, obstacle identifier 732 identifies the object 420 or ground condition 426 as a condition that would lead to a slip condition or a collision with the implement or vehicle 10. Obstacle identifier 732 may use a neural network, machine learning, or any other suitable method of identifying object 420 or ground condition 426 from image data. In some embodiments, obstacle identifier 732 is performed locally on vehicle 10. In other embodiments, obstacle identifier 732 may be performed remotely from vehicle 10. In some embodiments, the obstacle avoidance manager 734 may determine a need to adjust an operating parameter to avoid a predicted slip condition or collision based on the output of the obstacle identifier 732. In some embodiments, the obstacle avoidance manager 734 adjusts a non-priority operating parameter, in other embodiments, the obstacle avoidance manager 734 adjusts the priority operating parameter to avoid the potential collision or slip condition. For example, the priority operating parameter may be the Process 900 includes performing the needed adjustment to the non-priority operating parameter (step 910), according to some embodiments. In some embodiments, the obstacle detection manager 730, the obstacle identifier 732, and/or the obstacle avoidance manager 734 sends a control signal to the control system 200, which in turn sends a control signal to one of the driveline 50, the braking system 202, and/or implement system 204 to adjust the non-priority operating parameter.

Referring to FIG. 10, a flow diagram of a process 1000 for controlling the slip of a tractive element of an agricultural vehicle includes the steps 1002-1010. In some embodiments, the process 1000 is performed autonomously by a controller utilizing a neural network and a machine learning model. The neural network may be housed locally on the agricultural vehicle or, alternatively, the neural network may be housed remotely and be in communication with the agricultural vehicle wirelessly through the use of various wireless communication protocols, including, but not limited to, Wi-Fi, cellular, Bluetooth, etc.

Process 1000 includes obtaining an indication of a priority operating parameter (step 1002), according to some embodiments. In some embodiments, the priority operating parameter 750 can be obtained by the user input 741 of operator interface 40 through the use of various interactive elements of a graphical user interface displayed on display 739. In several embodiments, these interactive elements include radio buttons, sliders, checkboxes, text inputs, dials, etc. In other embodiments, the user may use physical controls as the user input 741. In some embodiments, the operator interface is housed within vehicle 10. In other embodiments, the operator interface is housed remotely of vehicle 10. User input 741 may come from a remote operator. In other embodiments, user input may come from an operating parameter database 650 housed remotely from vehicle 10 and based at least in part on a priority operating parameter of vehicles 610a-610n.

Process 1000 includes obtaining operating parameter data (step 1004), according to some embodiments. In some embodiments, components of driveline 50, braking system 202, and/or implement system 204 transmit operating parameter data to controller 702. Operating parameter data may be displayed on operator interface 40 in some embodiments. In other embodiments, the operating parameter data may also be sent to a remote database storage (e.g., operating parameter database 650).

Process 1000 includes obtaining a corresponding location data in relation to the operating parameter data (step 1006), according to some embodiments. In some embodiments, location sensor 740 transmits location data corresponding to the obtained operating parameter data to controller 702. Location sensor 740 may obtain the location data through any suitable method of obtaining location data. In some embodiments, location sensor 740 is a GPS unit. In other embodiments, location sensor 740 uses other location-tracking technology (e.g., RFID tracking, Wi-Fi, cellular, etc.).

Process 1000 includes recording the operating parameter data and the corresponding location data (step 1008), according to some embodiments. Once obtained, the location data may be stored locally on vehicle 10 (e.g., in memory 710) or remotely (e.g., in location database 620). Once obtained, operating parameter data may be stored locally on vehicle 10 (e.g., in memory 710) or remotely (e.g., in operating parameter database 650).

Process 1000 includes employing machine learning to perform an adjustment to at least one non-priority operating parameter of vehicle 10 (step 1010), according to some embodiments. In some embodiments, the controller 702 transmits the operating parameter data with corresponding location data to location monitoring manager 736. Location monitoring manager 736 can then use machine learning to preemptively adjust a non-priority operating parameter to avoid a predicted slip condition based on the obtained operating parameter data and corresponding location data. The location monitoring manager 736 may also use known topography, map data, past or future weather conditions, etc. to predict future slip conditions. The obtained operating parameter data and corresponding location data may be previously generated from vehicle 10, or any other vehicle 610a-610n (individually or collectively). Operating parameter data and corresponding location data obtained and recorded by vehicle 610a-610n may be transmitted to operating parameter database 650 and location database 620, respectively. In some embodiments, the data stored in these databases may be accessed by any vehicle within a fleet (e.g., vehicle 10 and vehicles 610a-610n).

It should be understood that any of the process 800, the process 900, and the process 1000 may be performed by the controller 702. In some embodiments, the controller 702 is configured to perform any steps of the process 800, the process 900, or the process 1000 at least partially simultaneously with each other. For example, the controller 702 may perform the steps 1008-1010 of the process 1000 (e.g., recording operating parameter data, slip conditions, and corresponding location data and employing machine learning or uploading the operating parameter data, the slip conditions, and the corresponding location data to the cloud computing system 630 for aggregation with similar data from other vehicles 10) while performing any of the steps 802-810 of the process 800 to mitigate or reduce the slip of the vehicle 10.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” or “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen, and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The terms “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, a code that creates an execution environment for the computer program in question (e.g., a code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing, and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof (e.g., the driveline 50, the braking system 100, the control system 200, etc.) as shown in the various exemplary embodiments are illustrative only. Additionally, any element disclosed in one embodiment may be incorporated or utilized with any other embodiment disclosed herein.

What is claimed is:

1. An agricultural vehicle comprising:
a control system configured to control slip of a tractive element, the control system comprising processing circuitry configured to:
obtain an indication of a priority operating parameter of a plurality of operating parameters of the agricultural vehicle;
responsive to a slip of the tractive element exceeding a threshold:
perform an adjustment to at least one of the plurality of operating parameters other than the priority operating parameter; and
operate the agricultural vehicle according to the adjustment to the at least one of the plurality of operating parameters other than the priority operating parameter and the priority operating parameter;
responsive to the slip of the tractive element exceeding the threshold while operating the agricultural vehicle according to the adjustment to the at least one of the plurality of operating parameters:
perform an adjustment to the priority operating parameter; and
operate the agricultural vehicle according to the adjustment to the priority operating parameter and the adjustment to the at least one of the plurality of operating parameters other than the priority operating parameter.

2. The agricultural vehicle of claim 1, wherein obtaining the indication of the priority operating parameter comprises receiving a user input from an operator interface of the control system, the priority operating parameter comprising one of an implement depth, a vehicle ground speed, an implement load, and a vehicle load.

3. The agricultural vehicle of claim 1, wherein the plurality of operating parameters include a steering angle, a braking force, a differential lock position, a four-wheel drive engagement, an engine speed, a transmission gear setting, a power take-off speed, an implement depth, a vehicle ground speed, an implement load, and a vehicle load.

4. The agricultural vehicle of claim 1, the control system further configured to:
obtain operating parameter data;
obtain location data corresponding to the operating parameter data; and
record and collect the operating parameter data and the corresponding location data over a time period.

5. The agricultural vehicle of claim 4, wherein the processing circuitry is further configured to use a neural network to perform the adjustment to the at least one operating parameter of the plurality of operating parameters other than the priority operating parameter, the neural network trained based on the operating parameter data and the corresponding location data collected over the time period by the agricultural vehicle or by a plurality of other agricultural vehicles.

6. The agricultural vehicle of claim 4, wherein the agricultural vehicle is one of a plurality of agricultural vehicles in a fleet, wherein the plurality of agricultural vehicles have access to the operating parameter data and the corresponding location data recorded by the agricultural vehicle.

7. The agricultural vehicle of claim 5, further comprising a vision system comprising at least one camera configured to produce an image data of an area proximate the agricultural vehicle, the control system further configured to provide to or use the image data in at least one of:
an obstacle detection manager configured to identify a ground condition in a path of the agricultural vehicle in the image data;
an obstacle identifier configured to detect a slip condition in the path of the agricultural vehicle; and
an obstacle avoidance manager configured to employ machine learning to preemptively perform the adjustment to the at least one non-priority operating parameter from the plurality of operating parameters to avoid the slip condition.

8. A control system to control slip of a tractive element of an agricultural vehicle comprising processing circuitry configured to:
obtain an indication of a priority operating parameter from a plurality of operating parameters of the agricultural vehicle;
responsive to a first slip amount of the tractive element exceeding a threshold:
perform an adjustment to at least one non-priority operating parameter from the plurality of operating parameters of the agricultural vehicle;
operate the agricultural vehicle according to the adjustment to the at least one non-priority operating parameter;
responsive to a second slip amount exceeding the threshold while operating the agricultural vehicle according to the adjustment to the at least one of the plurality of operating parameters:
perform an adjustment to the priority operating parameter or a second non-priority operating parameter from the plurality of operating parameters; and
operate the agricultural vehicle according to the adjustment to the priority operating parameter or the second non-priority operating parameter from the plurality of operating parameters.

9. The control system of claim 8, further comprising an operator interface for obtaining the indication of the priority operating parameter, the operator interface configured to receive a user input of the indication of the priority operating parameter, the priority operating parameter comprising one of an implement depth, a vehicle ground speed, an implement load, and a vehicle load.

10. The control system of claim 8, wherein the plurality of operating parameters includes a steering angle, a braking force, a differential lock position, a four-wheel drive engagement, an engine speed, a transmission gear setting, a power take-off speed, an implement depth, a vehicle ground speed, an implement load, and a vehicle load.

11. The control system of claim 8, further configured to:
obtain an operating parameter data;
obtain a corresponding location data in relation to the operating parameter data; and
record the operating parameter data and the corresponding location data.

12. The control system of claim 11, further configured to employ machine learning to perform the adjustment to the at least one non-priority operating parameter from the plurality of operating parameters of the agricultural vehicle in accordance with the operating parameter data and the corresponding location data recorded by the agricultural vehicle.

13. The control system of claim 12, further comprising a vision system comprising at least one camera configured to produce an image data of an area proximate the agricultural vehicle, the control system further configured to:
provide the image data to at least one of:
an obstacle detection manager configured to identify a ground condition in a path of the agricultural vehicle in the image data;
an obstacle identifier configured to detect a slip condition in the path of the agricultural vehicle; and
an obstacle avoidance manager configured to employ machine learning to preemptively determine a needed adjustment to the at least one non-priority operating parameter from the plurality of operating parameters to avoid the slip condition; and
perform the needed adjustment to the at least one non-priority operating parameter from the plurality of operating parameters to avoid the slip condition.

14. A method to control slip of a tractive element of an agricultural vehicle comprising the steps of:
obtaining an indication of a priority operating parameter from a plurality of operating parameters of the agricultural vehicle;
responding to a first slip amount of the tractive element exceeding a threshold:
performing an adjustment to at least one non-priority operating parameter from the plurality of operating parameters of the agricultural vehicle;
operating the agricultural vehicle according to the adjustment to the at least one non-priority operating parameter;
responding to a second slip amount exceeding the threshold while operating the agricultural vehicle according to the adjustment to the at least one of the plurality of operating parameters;
performing an adjustment to the priority operating parameter or a second non-priority operating parameter from the plurality of operating parameters; and
operating the agricultural vehicle according to the adjustment to the priority operating parameter or the second non-priority operating parameter from the plurality of operating parameters.

15. The method of claim 14, further comprising an operator interface for obtaining the indication of the priority operating parameter, the operator interface configured to receive a user input of the indication of the priority operating parameter, the priority operating parameter comprising one of an implement depth, a vehicle ground speed, an implement load, and a vehicle load.

16. The method of claim 14, wherein the plurality of operating parameters includes a steering angle, a braking force, a differential lock position, a four-wheel drive engagement, an engine speed, a transmission gear setting, a power take-off speed, an implement depth, a vehicle ground speed, an implement load, and a vehicle load.

17. The method of claim 14, further comprising:
obtaining an operating parameter data;
obtaining a corresponding location data in relation to the operating parameter data; and
recording the operating parameter data and the corresponding location data.

18. The method of claim 17, further comprising employing machine learning to perform the adjustment to the at least one non-priority operating parameter from the plurality of operating parameters of the agricultural vehicle in accordance with the operating parameter data and the corresponding location data recorded by the agricultural vehicle.

19. The method of claim 18, further comprising:
providing an image data, produced by a vision system comprising at least one camera, to at least one of:
an obstacle detection manager configured to identify a ground condition in a path of the agricultural vehicle in the image data;
an obstacle identifier configured to detect a slip condition in the path of the agricultural vehicle; and
an obstacle avoidance manager configured to employ machine learning to preemptively determine a needed adjustment to the at least one non-priority operating parameter from the plurality of operating parameters to avoid the slip condition.

20. The method of claim 19, further comprising performing the adjustment to the at least one non-priority operating parameter from the plurality of operating parameters to avoid the slip condition.
